(19) United States
(12) Patent Application Publication
(10) Pub. No.: US 2002/0195427 A1
(43) Pub. Date: Dec. 26, 2002

(54) High-conductivity electrode wire for wire electric discharge machining

(75) Inventor: Takashi Miyoshi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: The Furukawa Electric Co., Ltd., Tokyo (JP)

(21) Appl. No.: 09/867,187

(22) Filed: May 29, 2001

(51) Int. Cl. B23H 1/06; B23H 7/08

(52) U.S. Cl. 219/69.12; 428/675

(57) ABSTRACT

A high-conductivity electrode wire for wire electric discharge machining, which comprises a core having an aggregate structure containing not less than 35% by volume of [111] crystal grain, and a covering layer formed on the core at a covering ratio of 2 to 30% and containing Zn or a Zn alloy with Zn content of not less than 30% by weight. This electrode wire is designed to exhibit a tensile strength (X) of 800 MPa or more, and an electric conductivity (Y) of 30 IACS % or more, a relationship between the X and the Y satisfying the following relational expression of:

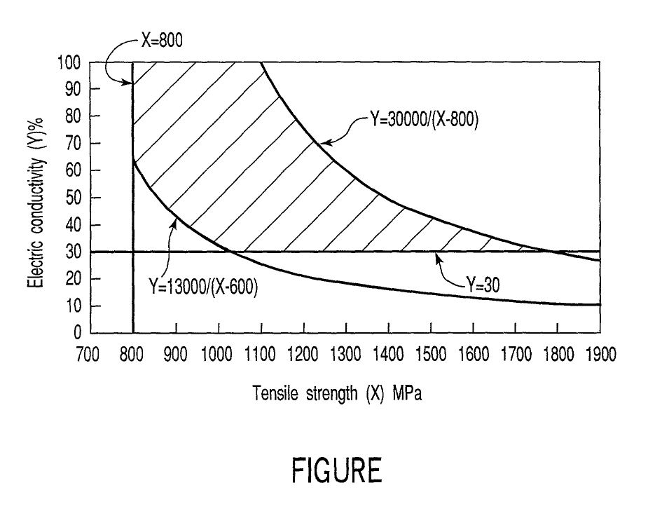

13000/(X−600)≦Y≦30000/(X−800).

### BACKGROUND OF THE INVENTION

The present invention relates to a high-conductivity electrode wire for wire electric discharge machining.

The wire electric discharge machining is a method wherein an electric discharge is caused to occur intermittently (in a pulse-like manner) between an electrode wire and a work piece through a processing liquid so as to fuse-cutting the work piece in a desired configuration. In order to realize a high-speed and high-precision cutting, the electrode wire to be employed for this wire electric discharge machining is required to be excellent in mechanical strength, in straightness and in roundness, and also required to be minimal in generation of deposit. For these reasons, various kinds of wires such as brass (Cu—Zn alloy) wire, Al-containing brass wire (see Japanese Patent Unexamined Publication S56-91308), zinc coated brass wire (see Japanese Patent Unexamined Publication S59-42116), tungsten wire, molybdenum wire, etc. have been conventionally employed.

Among these electrode wires, brass wire, Al-containing brass wire and zinc coated brass wire are advantageous in that they have a tolerable mechanical strength, and are excellent in discharge property due to the inclusion of Zn and in workability, and also advantageous in terms of cost due to relatively cheap material cost and excellent recyclability, but are accompanied with defects in that the precision of cutting work is insufficient, and the amount of generation of deposit is relatively large.

On the other hand, tungsten wire and molybdenum wire are high in mechanical strength, excellent in the precision of cutting work and minimal in the generation of deposit, but are poor in workability, making them very expensive.

In recent years, as the wire electric discharge machining is increasingly utilized, it is now strongly demanded to further improve the wire electric discharge machining in terms of the working precision as well as the working speed. Therefore, it is now increasingly demanded that the electrode wire should have a sufficiently high mechanical strength to provide a high tensile strength on the occasion of cutting work, and have such a high electric conductivity that enables a large electric current to pass therethrough.

However, the aforementioned conventional brass wire, Al-containing brass wire and zinc coated brass wire are insufficient in mechanical strength and in electric conductivity. On the other hand, the aforementioned tungsten wire and molybdenum wire are accompanied with the problem of high cost thereof as mentioned above.

### BRIEF SUMMARY OF THE INVENTION

Therefore, it is an object of the present invention to provide a high-conductivity electrode wire for wire electric discharge machining, which make it possible to perform high-speed cutting work, to obtain a high-precision cut section which is smooth and minimal in deposit matter, and to manufacture it cheaply.

According to the present invention, there is provided a high-conductivity electrode wire for wire electric discharge machining, which comprises a core member having an aggregate structure containing not less than 35% by volume of [111] crystal grain, and a covering layer formed on the core member at a covering ratio of 2 to 30% and containing Zn or a Zn alloy with Zn content of not less than 30% by weight; wherein the electrode wire is designed to exhibit a tensile strength (X) of 800 MPa or more, and an electric conductivity (Y) of 30 IACS % or more, a relationship between the X and the Y satisfying the following relational expression of:

13000/(X−600)≦Y≦30000/(X−800)

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

The single figure is a graph illustrating a tolerance zone of the tensile strength and of the electric conductivity according to the electrode wire of the present invention.

### DETAILED DESCRIPTION OF THE INVENTION

A first feature of the electrode wire according to the present invention resides in that it comprises a core member having an aggregate structure containing not less than 35% by volume of [111] crystal grain, and a covering layer formed on the core member at a covering ratio of 2 to 30% and containing Zn or a Zn alloy with Zn content of not less than 30% by weight.

The Zn or a Zn alloy covering the surface of the core member in the electrode wire according to the present invention functions to improve the discharging frequency and the vaporizing explosive force, thereby realizing an excellent discharging property.

The reason for limiting the content of Zn in the Zn alloy to not less than 30% by weight in the electrode wire of the present invention is that if the content of Zn in the Zn alloy is less than 30% by weight, it is difficult to sufficiently improve the discharging frequency and therefore to obtain an excellent discharging property. A preferable range of the content of Zn in the Zn alloy may be in the range of 35 to 70% by weight.

Further, the reason for limiting the covering ratio of the covering layer covering the core member to 2 to 30% in the electrode wire of the present invention is that if the covering ratio is less than 2%, it is difficult to sufficiently improve the discharging property, and that if the covering ratio exceeds over 30%, the space factor of the core member becomes too small to secure a sufficient mechanical strength of the electrode wire, thereby making it difficult to apply a sufficient tensile strength to the electrode wire. Any way, if the covering ratio of the covering layer covering the core member falls outside the range of 2 to 30%, the working precision would be deteriorated.

Furthermore, if the covering ratio is less than 2%, the core member wire (Cu wire) is more likely to be exposed, thereby giving rise to an increase in quantity of copper deposit. In this specification, by the expression of the covering ratio of the covering layer, it is intended to mean an area ratio of the covering layer containing Zn or Zn alloy with respect to the cross-sectional area of the electrode wire.

The core member of the electrode wire according to the present invention may preferably be selected from the group consisting of Cu-1.0-7.0 wt. % Ag alloy, Cu-0.1-3.5 wt. % Sn alloy, Cu-0.1-3.0 wt. % Sn-1.0-2.0 wt. % Ag alloy, Cu-0.5-3.5 wt. % Fe alloy, Cu-0.05-0.5 wt. % Mg alloy, and Cu-0.5-1.5 wt. % Mn alloy. It is possible with the employment of any of these alloys to obtain a sufficiently high mechanical strength and a sufficiently high electric conductivity. If the content of alloying elements in each of these alloys is less than the lower limit, the mechanical strength of the core member may become insufficient, thus making it difficult to obtain a satisfactory working precision. On the other hand, if the content of alloying elements in each of these alloys exceeds over the upper limit, the electric conductivity of the core member may be deteriorated, thereby making it difficult to realize a satisfactory working speed, thus leading to disadvantageous in terms of manufacturing cost.

It is also preferable that these alloys further contain at least one kind of element selected from the group consisting of up to 0.1% by weight of P, up to 0.5% by weight of Zn, up to 0.5% by weight of Cr and 0.5% by weight of Ni, with a proviso that the total of these elements to be added is at most 1.0% by weight.

Even if these additive elements such as P are added to the alloys in excess of the aforementioned upper limits, it may be difficult to expect any further improvement of their effects from such an excessive addition, which rather may lead to the deterioration of conductivity, thus making it difficult to obtain a satisfactory working speed.

By the way, for the purpose of obtaining a clear improvement in mechanical strength of the electrode wire, the content of P may be preferably at least 0.005% by weight, Zn at least 0.05% by weight, Cr at least 0.1% by weight, and Ni at least 0.3% by weight.

Generally, when the copper alloy that has been subjected to wire drawing work has an aggregate structure containing a mixture of [111] crystal grain (a crystal grain wherein the [111] crystal orientation is parallel with the longitudinal direction of the wire) and the [100] crystal grain (a crystal grain wherein the [100] crystal orientation is parallel with the longitudinal direction of the wire), and the volume percent of the [111] crystal grain increases, the copper alloy exhibits an increasingly higher mechanical strength. Even if the mechanical strength of the copper alloy becomes higher as mentioned above, it would not lead to the deterioration in tenacity of the alloy.

Since the electrode wire according to the present invention comprises a core member having an aggregate structure containing not less than 35% by volume of [111] crystal grain, it is possible to constantly obtain a high mechanical strength which is required for the high-speed cutting without deteriorating the tenacity of the core member.

The core member of the electrode wire according to the present invention can be manufactured by an ordinary method wherein an ingot of copper alloy is worked into an element wire through a sequence of steps including homogenizing heat treatment, hot rolling, cold rolling and drawing, the resultant element wire being subsequently subjected to wire drawing work while applying, as required, intermediate annealing to the element wire. In this case, when the area reduction ratio is set to 90% or more in the final wire drawing work, it becomes possible to obtain the aforementioned aggregate structure containing not less than 35% by volume of [111] crystal grain. If it is desired to further increase the mechanical strength of the electrode wire, the area reduction ratio should be set to 99% or more.

A second feature of the electrode wire according to the present invention resides in that the electrode wire is designed to exhibit a tensile strength (X) of 800 MPa or more, and an electric conductivity (Y) of 30 IACS % or more, a relationship between said X and said Y satisfying the following relational expression of:

13000/(X−600)≦Y≦30000/(X−800)

The reasons for limiting the tensile strength (X) of the electrode wire to 800 MPa or more and at the same time, limiting the electric conductivity (Y) to 30 IACS % or more are that if the tensile strength (X) is less than 800 MPa, it may be difficult to obtain a satisfactory working precision, and that if the electric conductivity (Y) is less than 30 IACS %, it may be difficult to obtain a desirable working speed. Furthermore, if the electric conductivity (Y) is 30 IACS % or more, the temperature increase of the electrode wire due to Joule heat can be minimized, thus leading to the advantage that the mechanical strength of the electrode wire would be hardly deteriorated during the working thereof.

The tolerable ranges of the tensile strength and electric conductivity of the electrode wire according to the present invention are indicated by the shaded area shown in FIGURE.

Further, the reasons for taking up the relationship between the electric conductivity (Y) and the tensile strength (X) as one of the conditions in the present invention, the relationship being defined by the relational expression of: 13000/(X−600)≦Y≦30000/(X−800), are that if the value of Y is smaller than the value of 13000/(X−600), the balance between the mechanical strength and the electric conductivity would be deteriorated, thereby making it difficult to constantly obtain satisfactory working speed and precision, and that if the value of Y is larger than the value of 30000/(X−800), the core member made of a low concentration alloy is required to be toughened, which is disadvantageous in terms of manufacturing cost.

The electrode wire according to the present invention may preferably have a diameter ranging from 0.01 to 0.4 mm. Because if the diameter of the electrode wire is too small, it may be difficult for the electrode wire to withstand the magnitude of tensile strength to be applied to the electrode wire during the step of electric discharging work. On the other hand, if the diameter of the electrode wire is too large, the working precision to be obtained may be deteriorated. In view of these reasons, a more preferable range of the diameter of the electrode wire would be from 0.05 to 0.3 mm.

### EXAMPLES

The present invention will be further explained in detail with reference to the following various examples.

### Example 1

27 kinds of copper alloys each having a composition shown in the following Tables 1 and 2 were melted and cast to obtain ingots, which were then subjected to hot-extrusion and then, drawing work to thereby obtain wires. These wires were then subjected to drawing work while intermediate-annealing to thereby obtain core members each having a wire diameter of 0.198 mm, 0.184 mm and 0.167 mm.

Then, these core members were respectively subjected to electroplating by making use of Zn, Cu-35 wt. % Zn alloy and Cu-70 wt. % Zn alloy to thereby obtain electrode wires each having a diameter of 0.2 mm.

By the way, as shown in the following Tables 1 and 2, various kinds of copper alloy were employed as the core members. These copper alloys were Cu-1.0-7.0 wt. % Ag alloy, Cu-0.1-3.5 wt. % Sn alloy, Cu-0.1-3.0 wt. % Sn-1.0-2.0 wt. % Ag alloy, Cu-0.5-3.5 wt. % Fe alloy, Cu-0.05-0.5 wt. % Mg alloy, and Cu-0.5-1.5 wt. % Mn alloy, one of these alloys further containing at least one kind of additional elements, i.e. up to 0.1% by weight of P, up to 0.5% by weight of Zn, up to 0.5% by weight of Cr and 0.8% by weight of Ni with a proviso that the total of these additional elements is at most 1.0% by weight

The area reduction ratio in the final drawing work of the core members was set to 99.8%, and the covering ratio of the core members was within the range of 2 to 30%.

### Comparative Example 1

An electrode wire was manufactured in the same manner as described in Example 1 except that a Cu—Sn alloy (No. 28) having the compositions as shown in the following Table 2 was employed and that the area reduction ratio in the final wire drawing work of the core member was set to 80%.

### Comparative Example 2

An electrode wire was manufactured in the same manner as described in Example 1 except that a Cu—Fe—Zn alloy (No. 29) having the compositions as shown in the following Table 2 was employed and that the area reduction ratio in the final wire drawing work of the core member was set to 85%.

### Comparative Example 3

Electrode wires were manufactured in the same manner as described in Example 1 except that Cu—Fe—Zn alloys (Nos. 30 and 31) having the compositions as shown in the following Table 2 were employed, that the wire diameter of the core members was set to 0.199 mm and 0.155 mm, and that the Zn-covering ratio of the core members was set to 1% and 40%.

### Comparative Example 4

Electrode wires were manufactured in the same manner as described in Example 1 except that Cu—Sn alloys (Nos. 28 and 29), Cu—Ag alloy (No. 34), Cu—Cr—Sn alloys (Nos. 35 and 36), Cu—Fe—Zn alloy (No. 37), Cu—Mg—Zn alloy (No. 38), Cu—Mn—Ni alloy (No. 39, 40), were employed.

By making use of the electrode wires manufactured in the above Example 1 and Comparative Examples 1 to 4, a copper block was cut out by means of electric discharge machining so as to investigate the maximum working speed within the working speeds which enable to obtain a smooth and high-precision cut surface, and at the same time, to investigate the amount of copper deposit adhered onto the cut surface of the copper block which had been cut out at the maximum working speed.

In this case, the amount of copper deposit was measured by analyzing the cut surface by means of EPMA. For the purpose of comparison, the conventional electrode wires which were manufactured by making use of a 65/35 brass core member, an Al-containing 65/35 brass core member, and a zinc coated 65/35 brass core member were also investigated in the same manner as described above.

The results are shown in the following Tables 1 and 2, in which the working speed and the amount of copper deposit are indicated by relative values based on the measured values which were obtained using the conventional 65/35 brass electrode wire and were provisionally set to 100, respectively. When the value of the working speed was found 150 or more, the test piece was determined as acceptable. Likewise, when the amount of the copper deposit was found not more than 85, the test piece was determined as acceptable.

In the following Tables 1 and 2, there are also shown the area reduction ratio in the drawing work, the volume percent of the [111] crystal grain of the core member, the covering materials and the covering ratios thereof, the tensile strength (TS) of electrode wire, and the electric conductivity (EC).

The volume percent of the [111] crystal grain of core member was measured by means of X-ray diffraction method, the tensile strength was measured on the basis of the JISZ2241, and the electric conductivity was measured on the basis of the JISH0505.

TABLE 1

| | | | Area | | | | | | | |
|---|---|---|---|---|---|---|---|---|---|---|
| | | | reduction | Volume | | | Covering | Covering | Working | Amount of |
| | No. | Composition of alloys | ratio (%) | percent | TS | EC | materials | ratio | speed | Cu deposit |
| Example 1 | 1 | Cu - 1.5 wt % Ag | 99.8 | 55 | 980 | 86 | Zn | 15 | 190 | 75 |
| | 2 | Cu - 5.5 wt % Ag | 99.8 | 53 | 1070 | 74 | Zn | 15 | 200 | 75 |
| | 3 | Cu - 3.0 wt % Ag | 99.8 | 55 | 1060 | 84 | Zn | 2 | 200 | 80 |
| | 4 | Cu - 3.0 wt % Ag | 99.8 | 53 | 970 | 68 | Zn | 30 | 170 | 72 |
| | 5 | Cu - 3.0 wt % Ag | 99.8 | 55 | 1080 | 75 | Zn35 | 15 | 200 | 78 |
| | 6 | Cu - 3.0 wt % Ag | 99.8 | 53 | 1110 | 69 | Zn35 | 30 | 200 | 70 |
| | 7 | Cu - 3.0 wt % Ag | 99.8 | 55 | 1020 | 71 | Zn70 | 15 | 180 | 75 |
| | 8 | Cu - 0.7 wt % Sn | 99.8 | 54 | 1030 | 52 | Zn | 15 | 170 | 75 |
| | 9 | Cu - 1.3 wt % Sn | 99.8 | 55 | 1130 | 37 | Zn | 15 | 160 | 72 |
| | 10 | Cu - 0.7 wt % Sn | 99.8 | 55 | 1050 | 58 | Zn | 2 | 190 | 80 |
| | 11 | Cu - 0.7 wt % Sn | 99.8 | 53 | 960 | 46 | Zn | 30 | 160 | 72 |
| | 12 | Cu - 1.3 wt % Sn | 99.8 | 55 | 1080 | 36 | Zn35 | 15 | 160 | 78 |
| | 13 | Cu - 1.3 wt % Sn | 99.8 | 55 | 1120 | 30 | Zn35 | 30 | 150 | 75 |
| | 14 | Cu - 2.0 wt % Sn - 0.1 wt % P | 99.8 | 55 | 1150 | 30 | Zn | 2 | 150 | 77 |
| | 15 | Cu - 0.15 wt % Cr - 2.0 wt % Sn | 99.8 | 55 | 950 | 37 | Zn | 15 | 150 | 75 |
| | 16 | Cu - 0.3 wt % Cr - 0.25 wt % Sn - 0.2 wt % Zn | 99.8 | 53 | 970 | 52 | Zn | 15 | 170 | 75 |
| | 17 | Cu 1.0 wt % Sn - 0.3 wt % Ag | 99.8 | 53 | 1130 | 50 | Zn | 2 | 180 | 75 |
| | 18 | Cu 1.2 wt % Fe - 0.2 wt % Zn | 99.8 | 55 | 820 | 64 | Zn | 15 | 160 | 75 |
| | 19 | Cu 2.4 wt % Fe - 0.4 wt % Zn | 99.8 | 55 | 840 | 62 | Zn | 15 | 160 | 75 |
| | 20 | Cu 2.6 wt % Fe - 0.8 wt % Zn | 99.8 | 54 | 880 | 53 | Zn | 15 | 150 | 75 |
| | 21 | Cu 2.3 wt % Fe - 0.1 wt % Zn - 0.05 wt % P | 99.8 | 55 | 850 | 65 | Zn | 2 | 170 | 79 |
| | 22 | Cu 0.3 wt % Mg - 0.2 wt % Zn | 99.8 | 36 | 970 | 58 | Zn | 2 | 170 | 83 |

(Notes)
Area reduction ratio: the area reduction ratio in the final wire drawing work of the core member.
Volume percent: the volume percent of the [111] crystal grain in the core member.
Covering materials: Zn means 100% of Zn; Zn35 means Cu - 35 wt. % Zn alloy; Zn70 means Cu - 70 wt. % Zn alloy;
TS: the tensile strength (unit: MPa).
EC: the electric conductivity (unit: % IACS) of electrode wire.
Working speed: a possible maximum working speed which enabled a smooth cut surface to be obtained and is shown by a relative value based on the working speed which was obtained using the brass electrode wire and was provisionally set to 100.
Quantity of copper deposit: a relative value based on the quantity of copper deposit which was deposited on a work piece (a steel block) when a brass electrode wire was employed, and was provisionally set to 100.

TABLE 2

| | | | Area | | | | | | | |
|---|---|---|---|---|---|---|---|---|---|---|
| | | | reduction | Volume | | | Covering | Covering | Working | Amount of |
| | No. | Composition of alloys | ratio (%) | percent | TS | EC | materials | ratio | speed | Cu deposit |
| Example 1 | 23 | Cu 0.3 wt % Mg - 0.2 wt % Zn | 99.8 | 56 | 1040 | 65 | Zn35 | 15 | 200 | 75 |
| | 24 | Cu 0.3 wt % Mg - 0.2 wt % Zn | 99.8 | 56 | 1100 | 60 | Zn35 | 30 | 200 | 72 |
| | 25 | Cu 0.3 wt % Mg - 0.2 wt % Zn | 99.8 | 56 | 1010 | 60 | Zn70 | 15 | 180 | 75 |
| | 26 | Cu 0.8 wt % Mn - 0.5 wt % Ni | 99.8 | 55 | 910 | 44 | Zn | 15 | 150 | 75 |
| | 27 | Cu 1.0 wt % Mn - 0.8 wt % Ni | 99.8 | 55 | 950 | 39 | Zn | 15 | 150 | 75 |
| Comparative | 28 | Cu - 4.5 wt % Sn | 99.8 | 56 | 1170 | 21 | Zn | 2 | 110 | 82 |
| Examples | 29 | Cu - 0.05 wt % Sn | 99.8 | 53 | 780 | 95 | Zn | 2 | 130 | 78 |
| | 30 | Cu - 0.7 wt % Sn | 80 | 25 | 800 | 49 | Zn | 2 | 140 | 80 |
| | 31 | Cu - 1.2 wt % Fe - 0.2 wt % Zn | 85 | 30 | 770 | 66 | Zn | 2 | 120 | 77 |
| | 32 | Cu - 1.2 wt % Fe - 0.2 wt % Zn | 99.8 | 55 | 820 | 64 | Zn | 1 | 140 | 95 |
| | 33 | Cu - 1.2 wt % Fe - 0.2 wt % Zn | 99.8 | 55 | 740 | 56 | Zn | 40 | 100 | 75 |
| | 34 | Cu - 0.3 wt % Ag | 99.8 | 53 | 680 | 98 | Zn | 2 | 120 | 80 |
| | 35 | Cu - 0.1 wt % Cr - 0.05 wt % Sn | 99.8 | 57 | 730 | 87 | Zn | 2 | 120 | 79 |
| | 36 | Cu - 0.1 wt % Cr - 3.5 wt % Sn | 99.8 | 52 | 1140 | 21 | Zn | 2 | 90 | 76 |
| | 37 | Cu - 0.4 wt % Fc - 0.2 wt % Zn | 99.8 | 52 | 720 | 68 | Zn | 2 | 120 | 77 |
| | 38 | Cu - 0.1 wt % Mg - 0.03 wt % Zn | 99.8 | 50 | 680 | 94 | Zn | 2 | 90 | 82 |
| | 39 | Cu - 0.4 wt % Mn - 0.5 wt % Ni | 99.8 | 58 | 750 | 49 | Zn | 2 | 90 | 72 |
| | 40 | Cu - 1.6 wt % Mn - 0.5 wt % Ni | 99.8 | 52 | 900 | 26 | Zn | 2 | 90 | 77 |
| Prior | 41 | 65/35 brass | — | — | 1000 | 21 | — | — | 100 | 100 |
| art | 42 | Al-containing 65/63 brass | — | — | 1150 | 18 | — | — | 120 | 95 |
| | 43 | Zn-covered 65/63 brass | — | — | 980 | 20 | Zn | 15 | 120 | 80 |

(Notes)
The definitions of items in this Table 2 are the same as illustrated with reference to Table 1.

As clearly seen from the above Tables 1 and 2, it was possible in all of samples Nos. 1 to 27 of Example 1 to obtain a smooth cut surface which was excellent in precision and minimal in deposited matter at a high-cutting speed.

The results can be attributed to the fact that since the core members of electrode wires according to this example were all excellent in mechanical strength and high in electric conductivity, it was possible to perform the electric discharge work under the conditions of high tensile strength and large electric current by making use of a relatively thin electrode wire, and to the fact that since the core members were provided with a suitable ratio of Zn covering, the discharge frequency was enabled to improve.

By contrast, since the sample No. 28 of Comparative Example contained a large amount of Sn and was low in electric conductivity, it was impossible to obtain a smooth cut surface with high precision at a high cutting speed. Likewisw, since the sample No. 29 of Comparative Example contained only a little amount of Sn and was low in mechanical strength, it was impossible to obtain a smooth cut surface with high precision at a high cutting speed.

Further, in the case of sample No. 30 of Comparative Example, since the electric conductivity (Y) and tensile strength (X) of sample No. 30 failed to meet the requisite of the present invention, i.e. the relational expression of: strength (X): 13000/(X−600)≦Y, it was impossible to obtain a smooth cut surface with high precision at a high cutting speed. Likewise, since sample No. 31 was small in area reduction ratio and low in volume percent of [111] crystal grain of core member and in tensile strength, since sample No. 32 was too small in covering ratio of Zn-covering layer and therefore failed to obtain excellent discharge property, and since sample No. 33 was too large in covering ratio of Zn-covering layer and therefore, poor in tensile strength due to a decrease in space factor of the core member, it was impossible, in all of these samples Nos. 31, 32 and 33, to obtain a smooth cut surface with high precision at a high cutting speed.

Further, since the mechanical strength was poor samples. Nos 34, 35, 37, 38, and 39, and since the electric conductivity was poor in all of the samples Nos. 36 and 40, it was impossible, in all of these samples, to obtain a smooth cut surface with high precision at a high cutting speed.

By the way, since the covering ratio of Zn-covering layer was too small in the case of sample No. 32, the core member was caused to expose, thereby increasing the quantity of copper deposit.

When every electrode wires obtained in Example 1 were investigated about the heat-resisting property, flexibility and stiffness thereof, all of which are requisite for the electrode wire, all of these electrode wires were confirmed to meet the specified ranges. If the stiffness is poor, the electrode wire tends to curl up, thus making it difficult to perform the automatic connection thereof.

### Example 2

The core members employed in Example 1 were subjected to wire drawing work while intermediate-annealing to thereby obtain very fine wires (0.01 to 0.07 mm in diameter), which were then covered with a Zn layer at a volume percent of 15% to thereby obtain electrode wires. Then, by making use of these electrode wires, a steel block was cut at a high cutting speed. As a result, it was possible, in all of these electrode wires, to obtain a smooth cut surface with high precision, the cut surface being substantially free from copper deposit. In the step of aforementioned drawing work, the area reduction ratio was changed to 90 to 99.8% at the final drawing work.

As explained above in detail, the electrode wire for wire electric discharge machining according to the present invention is high in mechanical strength so that a high tensile force can be applied to the electrode wire even if the electrode wire is reduced in diameter. Further, since the electrode wire according to the present invention is excellent in electric conductivity, a large quantity of working electric current can be applied to the electrode wire, and at the same time, the temperature increase due to Joule heat can be minimized. Additionally, according to the electrode wire of the present invention, the mechanical strength thereof would be hardly deteriorated during the cutting work. Furthermore, owing to a synergistic effect between the high mechanical strength and high conductivity of the core member and the discharge property-improving effect to be derived from the Zn-covering layer, it is now possible to obtain a smooth cut surface with high precision, the cut surface being substantially free from copper deposit.

Where the core member to be employed in the electrode wire of the present invention is constituted by a copper alloy, the core member is excellent in workability, cheap in material cost, suited for recycling, and hence advantageous in manufacturing cost. Therefore, the high-conductivity electrode wire for wire electric discharge machining according to the present invention is very useful in industrial viewpoint.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A high-conductivity electrode wire for wire electric discharge machining, comprising:
a core member having an aggregate structure containing not less than 35% by volume of [111] crystal grain; and
a covering layer formed on said core member at a covering ratio of 2 to 30% and containing Zn or a Zn alloy with Zn content of not less than 30% by weight,
wherein said electrode wire is designed to exhibit a tensile strength (X) of 800 MPa or more, and an electric conductivity (Y) of 30 IACS % or more, a relationship between said X and said Y satisfying the following relational expression of:
13000/(X−600)≦Y≦30000/(X−800).

2. The electrode wire according to claim 1, wherein said core member comprises at least one kind of alloys selected from the group consisting of Cu-1.0-7.0 wt. % Ag alloy, Cu-0.1-3.5 wt. % Sn alloy, Cu-0.1-3.0 wt. % Sn-1.0-2.0 wt. % Ag alloy, Cu-0.5-3.5 wt. % Fe alloy, Cu-0.05-0.5 wt. % Mg alloy, and Cu-0.5-1.5 wt. % Mn alloy.

3. The electrode wire according to claim 2, wherein said core member further contains at least one kind of elements selected from the group consisting of up to 0.1% by weight of P, up to 0.5% by weight of Zn, up to 0.5% by weight of Cr and 0.5% by weight of Ni, with a proviso that the total of these elements to be added is at most 1.0% by weight.

4. The electrode wire according to claim 3, wherein at least 0.005% by weight of P, at least 0.05% by weight of Zn, at least 0.1% by weight of Cr, or at least 0.3% by weight of Ni is added to said core member.

5. The electrode wire according to claim 1, wherein said electrode wire has a wire diameter ranging from 0.01 to 0.4 mm.

6. The electrode wire according to claim 1, wherein said core member has been subjected to a wire drawing work at an area reduction ratio of 90% or more.
